(19) United States
(12) Patent Application Publication
(10) Pub. No.: US 2018/0159286 A1
(43) Pub. Date: Jun. 7, 2018

(54) COMMUTATOR FOR A BRUSH-COMMUTATED ELECTRIC MOTOR HAVING AN EXTENDED COMMUTATION INTERVAL

(71) Applicants: SCHUNK HOFFMANN CARBON TECHNOLOGY AG, Bad Goisern (AT); AC2T RESEARCH GMBH, Wiener Neustadt (AT)

(72) Inventors: László Katona, Babarc (HU); András Vernes, Wien (AT); Georg Vorlaufer, Guntramsdorf (AT)

(21) Appl. No.: 15/576,394

(22) PCT Filed: May 24, 2016
(86) PCT No.: PCT/EP2016/061719

§ 371 Date: Nov. 22, 2017

(30) Foreign Application Priority Data
May 27, 2015 (DE) 10 2015 209 724.2

(51) Int. Cl. H01R 39/06; H02K 13/00; H01R 39/60

(52) U.S. Cl. CPC H01R 39/06; H01R 39/60; H02K 13/006

(57) ABSTRACT

The invention relates to a disc commutator and a drum commutator for an electric motor having at least two commutator plates, each having a sliding-surface segment for contacting a carbon brush, said sliding-surface segments being electrically separated from one another. In the disc commutator, the electrical separation extends between the sliding-surface segments towards a commutator diameter inclined at an angle α In the drum commutator, the electrical separation of the sliding-surface segments is inclined in the longitudinal direction of the drum commutator and forms an angle β with a projection of the rotational axis of the drum commutator on the casing surface of the drum commutator.

The invention relates to a disc commutator and a drum commutator for an electric motor having at least two commutator plates which each comprise a sliding-surface segment for contacting a carbon brush, said sliding-surface segments being electrically separated from one another.

Through the rotational movement of an electric motor having carbon brushes, two or more adjacent commutator plates are short-circuited during commutation. This causes the current direction to be reversed in the short-circuited coil with regard to the original current direction. In order to discharge the energy stored in the short-circuited coil during commutation, the commutation should last as long as possible. If the current of the short-circuited coil is not entirely reversed at the end of the commutation process, i.e. when separating the short circuit between the adjacent commutator plates, sparks can be formed between the carbon brush and the commutator plate and thus more material can be removed, i.e. a higher wear and a shortened service life of the carbon brush or commutator. Furthermore, the formed sparks negatively impact the functionality and the efficiency of the machine.

The object of the invention at hand is therefore to design a commutator for electric motors in such a manner that an improved commutation behavior is attained.

With respect to a disc commutator, this object is attained by the electric separation of the sliding-surface segments, which extends towards a commutator diameter in an inclined manner at an angle a, in conjunction with the preamble of claim 1.

With respect to a drum commutator, the object of the invention is attained by the electric separation of the sliding-surface segments being inclined in the longitudinal direction of the drum commutator and forming an angle β with a projection of the rotational axis of the drum commutator on the casing surface of the drum commutator in conjunction with the preamble of claim 3.

A longer commutation duration is achieved via the new geometry of the commutator, e.g. via the targeted geometry of the sliding-surface segments by means of orienting the electric separation between the individual (sliding-surface segments of the) commutator plates in a manner according to the invention—the electrical separation corresponding in practice to a gap between two sliding-surface segments. Through this measure, the possibility of sparks forming when opening the plates contact can be prevented, which can lead to an increased service life and an improved operation of the electric machine.

In particular the angle interval, in which the carbon brush is contacted to (several sliding-surface segments of) several commutator plates, is enlarged and consequently the duration (commutation duration) is increased in which at least one coil is short-circuited. The consequence of this is that the source voltage decreases in the affected branch via fewer coil resistances and the machine thus accommodates a higher electric power, depending on the relation between the contact resistance and the coil resistance.

In the case of the disc commutator, the electrical separation between the individual sliding-surface segments no longer extends radially outward from the rotational axis of the commutator but is rather inclined at an angle α with respect to the commutator diameter.

In the case of the drum commutator, the electrical separation of the sliding-surface segments—viewed on the unwound casing surface—is no longer arranged parallel to the rotational axis of the commutator but rather forms an angle β with a projection of the rotational axis of the drum commutator on the casing surface of the drum commutator.

The optimization is based on the calculation of a geometry of the sliding-surface segments optimal for an as long as possible commutation duration under consideration of an inexpensive production. The angle α or β thus comprises values which are optimized under the criterion of an as long as possible commutation duration.

Further advantageous embodiments can be taken from the following description and the drawings which describe a preferred embodiment of the invention by means of an exemplary disc commutator. In the drawings,

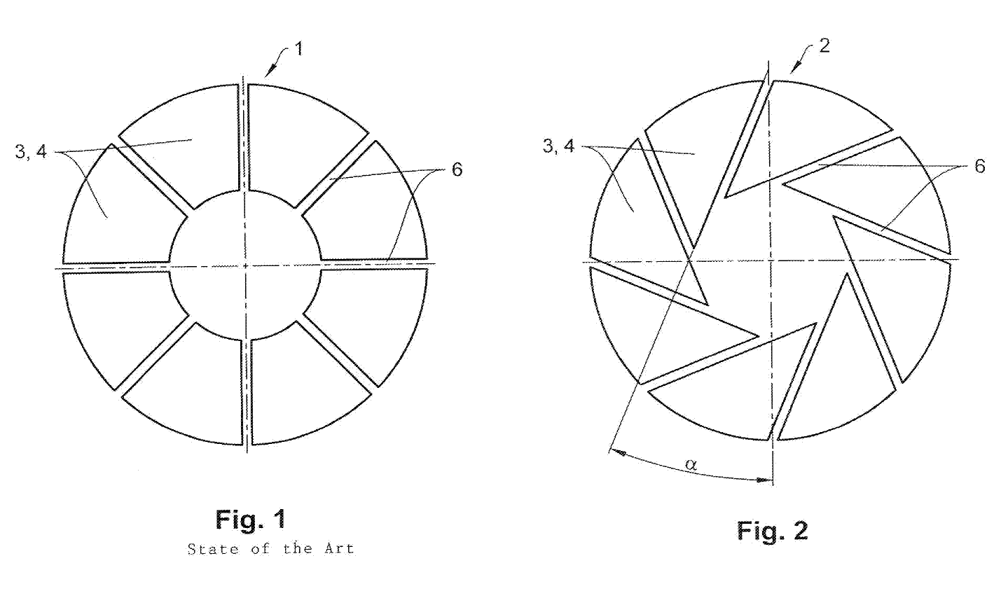

FIG. 1 shows the geometry of the sliding-surface segments and the arrangement of their electrical separation (gap) of a disc commutator according to the state of the art,

FIG. 2 shows the geometry of the sliding-surface segments and the arrangement of their electrical separation (gap) of the disc commutator according to the invention,

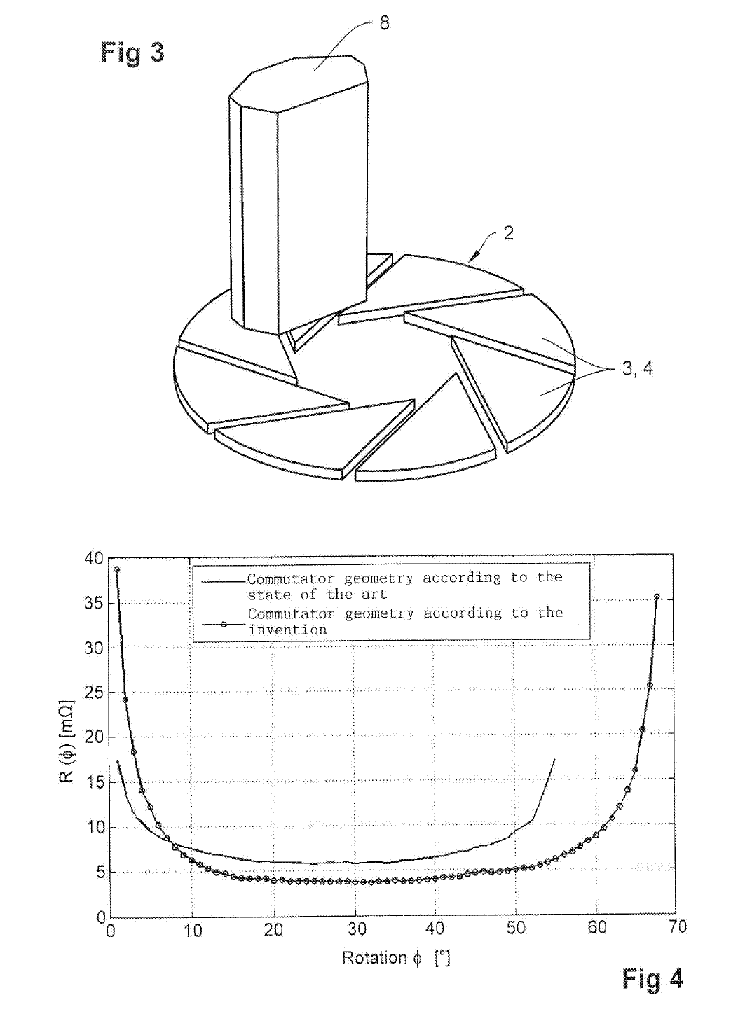

FIG. 3 shows a three-dimensional view of the geometry of the sliding-surface segments and the arrangement of their electrical separation (gap) of the disc commutator according to the invention having a carbon brush,

FIG. 4 shows simulation results for cross resistances,

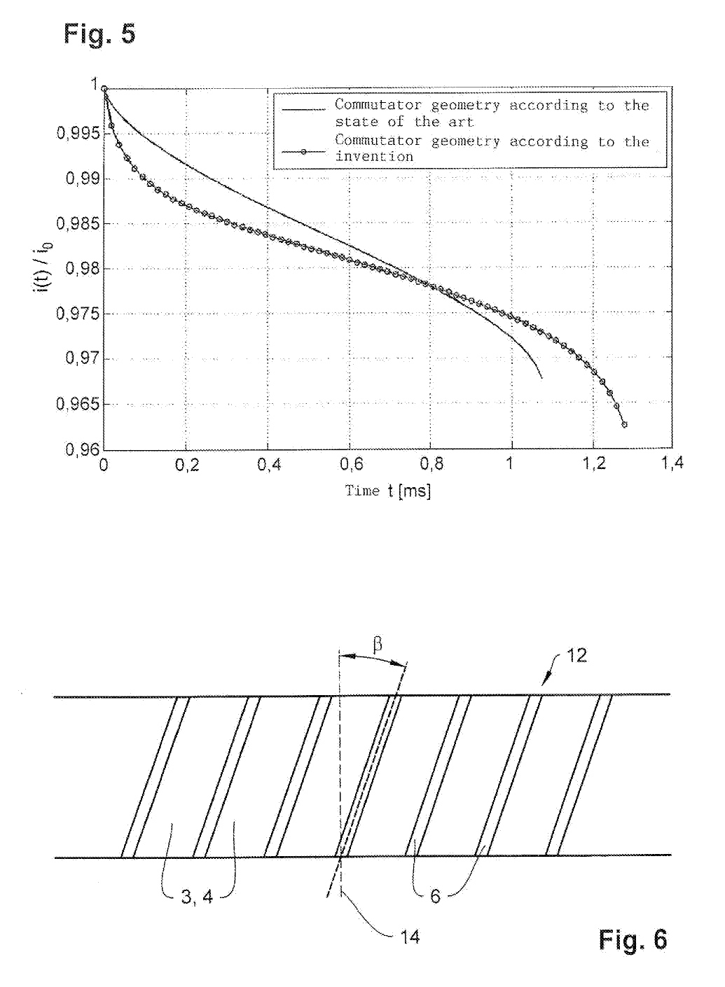

FIG. 5 shows the discharge behavior of the current of a coil via the resistances from FIG. 4, and

FIG. 6 shows an unwound casing surface of a drum commutator according the invention having the geometry of the sliding-surface segments and the arrangement of their electrical separation (gap).

FIG. 1 schematically illustrates the geometry of the sliding-surface segments 4 of a disc commutator 1 according to the state of the art. The disc commutator 1 comprises eight commutator plates 3 each having a sliding-surface segment 4, said individual commutator plates 3 or rather their sliding-surface segments 4 being electrically separated via electrical separations 6 (gap) extending radially. Through this, an axisymmetric division of the disc surface is attained in in turn axisymmetric sliding-surface segments 4.

In contrast to this, the electrical separations 6 (gap) extend between the commutator segments 3 or rather the sliding-surface segments 4 towards a commutator diameter in an inclined manner at an angle α in the geometry shown in FIG. 2 of the sliding-surface segments 4 of the disc commutator 2 according to the invention.

FIG. 3 illustrates a three-dimensional view of the geometry of the sliding-surface segments 4 of the disc commutator 2 according to the invention having a carbon brush 8.

In comparison to the geometry of the sliding-surface segments 4 of a disc commutator 1 according to the state of the art, an extended commutation duration is yielded (FIG. 4). This means a longer period for commutation of the current in the short-circuited coil is available at the same rotation speed of the electric motor. Moreover, a stronger accommodated electric power can follow.

In a diagram in FIG. 4, simulation results for cross resistances of a standard carbon brush 8 are represented as a function of the rotational angle φ.

The simulated progress of the cross resistances of the carbon brush on a commutator 1 according to the state of the art is contrasted to the progress on the optimized commutator 2 (commutator geometry according to the invention). It can be seen from these progresses that the resistance is increased at the beginning and at the end of the commutation process (rotation angle 1° to 6° and 62° to 68°). This is yielded from the nominal contact surfaces in these areas of the commutation being smaller in the optimized commutator geometry than in the geometry known from the state of the art. Furthermore, it can be seen at the x-axis in FIG. 4 (rotational angle φ) that the contact between the carbon brush 8 and the sliding-surface segment 4 of the commutator plate 3 is extended by 13° on the innovative commutator with respect to the known geometry according to the state of the art.

FIG. 5 illustrates the discharge behavior of the current of a coil via the cross resistances of the brush, simulated on the new commutator 2 (commutator geometry according to the invention) and on the commuta tor 1 according to the state of the art in comparison. It can be seen that a reduction increased by approximately 15% is yielded in relation to the relative discharge behavior of the current. In FIG. 5, it can be seen on the time axis (x-axis) that the commutation lasts 0.1 ms, i.e. approximately 10%, longer at the same rotational speed (9,000 rpm) than on the geometry according to the state of the art.

FIG. 6 illustrates an unwound casing surface of a drum commutator 12 according to the invention. The electrical separations 6 (gap) between the sliding-surface segments 4 of the commutator plates 3 form an angle β with a projection of the rotational axis 14 of the drum commutator 12 on the casing surface of the drum commutator (12).

1. A disc commutator for an electric motor having at least two commutator plates which each comprise a sliding-surface segment for contacting a carbon brush, said sliding-surface segments being electrically separated from one another, wherein
the electrical separation of the sliding-surface segments extends towards a commutator diameter in an inclined manner at an angle α.

2. The disc commutator for an electric motor according to claim 1,
wherein
the angle α comprises a value which is optimized under the criterion of an as long as possible commutation duration.

3. A drum commutator for an electric motor having at least two commutator plates which each comprise a sliding-surface segment for contacting a carbon brush, said sliding-surface segments being electrically separated from one another,
wherein
the electric separation of the sliding-surface segments is inclined in the longitudinal direction of the drum commutator and forms an angle β with a projection of the rotational axis of the drum commutator on the casing surface of the drum commutator.

4. The drum commutator for an electric motor according to claim 3,
wherein
the angle β comprises a value which is optimized under the criterion of an as long as possible commutation duration.
